(19) United States
(12) Patent Application Publication
(10) Pub. No.: US 2023/0330701 A1
(43) Pub. Date: Oct. 19, 2023

(54) PROCESS FOR PREPARING ROLLS FOR USE IN COATING PLANTS, AND ADHESIVE TAPE FOR PREPARING ROLLS

(71) Applicant: tesa SE, Norderstedt (DE)

(72) Inventors: Niels CZERWONATIS, Hamburg (DE); Ingo NEUBERT, Norderstedt (DE)

(73) Assignee: tesa SE, Norderstedt (DE)

(21) Appl. No.: 18/134,201

(22) Filed: Apr. 13, 2023

(30) Foreign Application Priority Data
Apr. 14, 2022 (DE) 10 2022 109 186.4

(51) Int. Cl. B05D 1/28; C09J 7/24; C09J 183/04; C09J 7/38; C09J 7/29

(52) U.S. Cl. CPC B05D 1/28; C09J 7/243; C09J 183/04; C09J 7/38; C09J 7/29; C09J 2301/302; C09J 2301/312; C09J 2301/162

(57) ABSTRACT

Rolls for use in coating plants and processes for preparing said rolls is disclosed. The rolls and processes comprise at least: a) providing a coating plant with a roll having a lateral face intended for contact with a substrate to be coated; b) producing or providing an adhesive tape comprising i) a carrier layer consisting at least partly of ethylene-tetrafluoroethylene copolymer, and ii) an adhesive layer disposed on the carrier layer and consisting at least partly of a silicone adhesive; and c) adhering the adhesive tape to the lateral face of the roll by means of the adhesive layer to give or provide a prepared roll.

This is an application based on German patent application DE 10 2022 109 186.4, filed Apr. 14, 2022. The present application claims the full priority benefit of this prior application and incorporates by reference its full disclosure as if set forth herein.

The invention relates to a process for preparing rolls for use in coating plants, to a process based thereon for coating a perforate substrate with a coating plant, to an adhesive tape for use in these processes, to the use of such an adhesive tape for preparing rolls, to a roll thus prepared, and to a coating plant for coating substrates. Also disclosed is a process for producing such adhesive tapes.

In many areas of industry there is a need to provide sheetlike substrates with a coating that enables the surface properties of these substrates to be tailored to the particular usage requirements. One effective process for applying thin polymeric layers to sheetlike substrates is that known as extrusion coating, where the superficial coating of the substrate is generated from a polymer melt. In the coating plants employed in this context, the shaping of the thin coating on the surface of the substrate is generally accomplished by passing the sheetlike substrate to be coated, after contacting with the hot polymer melt, through a roll arrangement, where the roll arrangement, through the use of water-cooled rolls, for example, usually also promotes the cooling of the hot polymer melt and hence the solidification of the coating.

In practice, in the context of extrusion coating, a challenge is posed insofar as it is generally desirable to minimise direct contact between the hot polymer melt and the rolls of the roll arrangement that are not metal rolls used for cooling. The risk of contact between the hot polymer melt and these guide rolls or opposed rolls, which are usually disposed beneath the substrate, exists in particular at the so-called coating edges, i.e. at those parts of the roll that protrude on both sides beyond the substrate to be coated. However, beyond this possible contact point, there may additionally be further potential contact points between the hot polymer melt and the guide rolls, specifically when the sheetlike substrates to be coated have continuous clearances which are vital for the later end use but which complicate coating in an extrusion coating process. Such continuous clearances in substrates to be coated are customary in particular in the area of the packaging industry and serve the purpose, for example, of realising functional openings in the subsequent packaging, such as the spout of a beverage carton, for example.

In order to prevent the hot polymer melt making contact with the underlying guide rolls or opposed rolls, these rolls are sometimes in the prior art taped off locally with an adhesive tape matched specifically to that application, known as an “anti-adhesive” tape, so that the parts of the lateral roll face that might come into contact with hot polymer melt in the marginal regions of the substrate or the region of any continuous clearances are covered locally by the adhesive tape. Especially for protecting the marginal regions of the rolls, however, there are alternative solutions known, particularly the use of corresponding “anti-adhesive” belts, which are passed over the rolls of the roll arrangement.

Through the use of these specific “anti-adhesive” tapes for preparing rolls in coating plants for extrusion coating, the risk of direct contacting of the unprotected surfaces of the rolls with the hot polymer melt can be reduced or even—at least for a certain time—prevented entirely, so making it possible to reduce the risk of contamination or possibly even damage of the coating plant. Relevant disclosures and further information on the technical background are found for example in US 20080156443 A1 or JP 2004083706 A.

In the prior art, adhesive tapes used for the “anti-adhesive” tapes are, in particular, those tapes which have a carrier layer made of PTFE, i.e. polytetrafluoroethylene. Following the application of the adhesive tapes to the rolls, this carrier layer forms a local surface covering and by virtue of the physicochemical properties of the PTFE makes it possible—at least for a certain time—to implement the extrusion coating reliably without excessively reducing the lifetime of the guide rolls or opposed rolls.

In spite of the fundamental advantages of such adhesive tapes and of the roll preparation processes carried out with them, the service lives that are attainable in the application with the adhesive tapes known from the prior art are in some cases perceived as being inadequate, especially with regard to the abrasion resistance of the bonded covering, the release effect achieved relative to the polymer melt and the temperature stability. There is therefore a continual need to improve the corresponding processes for readying rolls for extrusion coating, and the adhesive tapes employed in this context.

A particular disadvantage perceived in the adhesive tapes known from the prior art is often their costly and complicated production and the processing qualities, which in many cases are perceived as being inadequate. The reason is that corresponding carrier layers of PTFE film require, for their production, usually a very costly and complicated sintering process with a subsequent peeling operation. In order to achieve sufficient mechanical strength for the intended application, the PTFE film thus produced has to be subsequently calendered in a relatively complex operation, and in many cases this operation also limits the achievable working width of the carrier layers and hence, indirectly, the maximum width of the adhesive tapes that can be produced.

In order to achieve satisfactory anchoring of the adhesive used on the PTFE film, it is necessary, moreover, usually to carry out costly and complicated etching, with sodium naphthalide, for example; this etching, owing to the harsh conditions and the chemicals used, is generally perceived as being disadvantageous in view of the manufacturing effort, the workplace safety measures required, and the sustainability of the production process. In spite of these costly and complicated measures for boosting the adhesion of the adhesive layer on the carrier layer of PTFE, the attainable bond strength is in many cases still not rated as being satisfactory, especially because the surface etching generated is subject to an aging process that may adversely affect the bond strengths achievable in the production of adhesive tapes.

Furthermore, the PTFE-based “anti-adhesive” tapes known from the prior art require comparatively thick carrier layers and a comparatively high coatweight of adhesive—with regard to the demand for materials and the resultant unit costs, this is frequently rated as being disadvantageous. The resulting adhesive tapes, moreover, because of their thickness, in operation, generate an uneven pressure profile between the rolls on the prepared rolls, and this may result in impressions of the adhesive tape being left on the prepared roll after a certain operational time, with these unevennesses necessitating changeover of the entire roll and so possibly adversely reducing the roll service life.

A further perceived disadvantage is that in many cases the PTFE carrier layers used in the prior art are difficult to colour. Such colouring, however, with a view to the handling properties of the adhesive tape in the preparation of rolls and in particular for continuous quality control during the coating operation, is desirable, and so, in the case of the PTFE-based adhesive tapes known from the prior art, the adhesive provided in the adhesive layer is occasionally coloured, with the disadvantageous consequence, however, that coloured residues of adhesive may remain on the surface of the roll after the adhesive tapes have been removed.

The primary object of the present invention was to eliminate or at least reduce the above-described disadvantages of the prior art.

More particularly it was an object of the present invention to specify a process for preparing rolls for coating plants, and an adhesive tape suitable for this purpose, which in comparison with the process known from the prior art can be operated in a more time-efficient and cost-effective way.

Accordingly, it was an object of the present invention that the adhesive tapes used for preparing rolls ought to be easier to produce than in the prior art. Moreover, these adhesive tapes ought to be easier to colour in order to improve the handling properties. The adhesive tapes to be specified, moreover, in spite of the greater ease of production, ought to have a high mechanical strength and an excellent bond strength between the adhesive layer and the carrier layer.

Against this background, it was an object of the present invention that the prepared rolls to be produced with the process to be specified should have a long service life, more particularly a high abrasion resistance, a pronounced temperature stability, and a consistently advantageous release effect relative to the hot polymer melt, so that the bonded covering on the prepared rolls need not be replaced so often, with a consequent extension to the service lives.

In this connection, it was an object of the present invention that the adhesive tapes to be specified ought ideally to be able to be made thinner than the solutions known from the prior art, so allowing material savings to be realised, preferably both in the carrier layer and in the adhesive layer. It was, accordingly, an object to reduce the energy consumption required in production, and the demand for chemicals potentially injurious to health.

It was an object of the present invention, moreover, to reduce the adverse effect of the bonded covering on prepared rolls on the service life of the rolls as well, this adverse effect possibly arising from the generation of imprints of the adhesive tapes on the roll.

It was a secondary object of the present invention to specify a process for coating a perforate substrate with a coating plant. A supplementary object of the present invention, moreover, was to specify the use of such adhesive tapes for preparing rolls for use in coating plants. Resulting from this also is the additional object of the present invention to specify a prepared roll and an associated coating plant.

The inventors of the present invention have now found that the objects above can surprisingly be achieved if, in a process for preparing rolls for use in coating plants, an adhesive tape is used which is based on the combination of an ETFE-based carrier layer with a silicone adhesive, as defined in the claims.

The objects stated above are therefore achieved by the subject matter of the invention as it is defined in the claims. Preferred inventive embodiments are evident from the dependent claims and from the observations below.

Embodiments denoted below as being preferred are combined in particularly preferred embodiments with features of other embodiments denoted as being preferred. Very particularly preferred, accordingly, are combinations of two or more of the embodiments identified below as being particularly preferred. Likewise preferred are embodiments in which a feature of one embodiment, denoted to any extent as being preferred, is combined with one or more further features of other embodiments, which are denoted to any extent as being preferred. Features of preferred prepared rolls, coating plants, adhesive tapes, uses and production processes are apparent from the features of preferred processes.

The invention relates to a process for preparing rolls for use in coating plants, comprising the process steps of:
a) providing a coating plant with a roll having a lateral face intended for contact with a substrate to be coated,
b) producing or providing an adhesive tape comprising:
   i) a carrier layer, the carrier layer consisting at least partly of ethylene-tetrafluoroethylene copolymer, and
   ii) an adhesive layer disposed on the carrier layer, the adhesive layer consisting at least partly of a silicone adhesive, and
c) adhering the adhesive tape to the lateral face of the roll by means of the adhesive layer, to give a prepared roll, the adhering taking place such that the lateral face of the prepared roll is covered at least partly by the adhesive tape.

The process of the invention serves for preparing rolls for use in coating plants, more particularly those plants for extrusion coating, and is suitable more particularly for rolls of extrusion plants which are used for sheetlike substrates such as, for example, beverage packaging, sealable films or materials for packaging.

In a first process step a), first of all a roll is provided, this being expediently a guide roll or opposed roll that in the coating plant is subject to the risk of coming into contact with the hot polymer melt. Preferred in this context is a process of the invention wherein the roll is provided as a roll disposed in a coating plant.

The lateral face of this roll is intended for contact with the substrate guided through the coating plant, and which in the coating plant is then guided over the now prepared lateral face of the roll; in practice it is possible for the contacting to take place at least partly indirectly, with further plies being disposed between the roll and the substrate. In accordance with the understanding of the skilled person, the lateral face of a roll is that part of the surface of the cylindrical roll body that is not formed by the end faces. Serving as a second component of the process of the invention is an adhesive tape. This adhesive tape may be provided, for example by purchase from a manufacturer specialised in adhesive tapes, or may be produced as part of the process of the invention, by application of the production process disclosed below, for example.

The adhesive tape used in the process of the invention comprises a carrier layer and an adhesive layer, which are joined to one another. A feature of the adhesive tape for use in the invention is that the carrier layer consists at least partly of ETFE, i.e. of ethylene-tetrafluoroethylene copolymer, while the adhesive layer is formed at least partly by a silicone adhesive. The material ETFE, i.e. ethylene-tetrafluoroethylene copolymer, is a fluorinated copolymer which comprises monomer units derived from tetrafluoroethylene and ethylene and which can be acquired in various forms, in particular in the form of ETFE films, from various manufacturers; in the building industry, for example, it is fairly widely utilised as covering material, as in the construction of sports arenas, for example.

Silicone adhesives constitute a specific sub-type of adhesives, being well known to the person skilled in the art of bonding technology, and being used in many commercially available adhesive tapes, with the consequence that for the adhesive tape for use in the invention, the skilled person is able to draw without constraint on silicone adhesives with which they are familiar.

In process step c), the adhesive tape produced or provided is then applied, with the adhesive layer leading, to the lateral face of the roll, so as to give a prepared roll whose lateral face is covered at least partly by the adhesive tape. Conducively, the bonded covering of the lateral face of the prepared roll is adjusted here to the anticipated exposure in the coating plant, so that with its carrier layer the adhesive tape covers those parts of the prepared roll that in subsequent use run the risk of coming into contact with the hot polymer melt.

With a view to the target application, preference here is given to a process of the invention wherein the adhesive tape is a single-sided adhesive tape and/or wherein the adhesive tape consists of the carrier layer and the adhesive layer. Also preferred, against this background, is a process of the invention wherein the adhesive tape is adhered to the lateral face of the roll such that the surface of the prepared roll is formed at least partly by the carrier layer.

The inventors have recognised that with adhesive tapes of this kind it is possible to obtain excellent prepared rolls which, in comparison to rolls prepared with PTFE-based adhesive tapes, permit longer service lives of the bonded covering, especially in relation to the abrasion resistance and the stability at the high operating temperatures, with rolls thus prepared displaying an excellent release effect in relation to customary polymer melts, including polyethylene melts in particular.

This ETFE-based carrier layer, advantageously, is significantly easier to produce than the carrier layers known from the prior art, and may be produced advantageously via relatively simple flat film extrusion. Moreover, the ETFE-based carrier layer offers the advantage that unlike PTFE it can be easily coloured and so makes it unnecessary to colour the adhesive.

A particular advantage in connection with the production of the adhesive tapes may be seen as being that the surface tension of the ETFE-based carrier layer, without the need for an etching step, can be increased through a typical corona treatment, it being possible advantageously for this corona treatment, indeed, to take place “inline” with the application of the adhesive, so making it possible substantially to rule out any adverse effect of aging on the surface activation. Surprisingly, the resultant combination of the ETFE-based carrier layer with the silicone adhesive exhibits excellent bond strength and advantageous mechanical stability, which in particular also enables the use of relatively thin carrier layers and/or an adhesive coatweight reduced relative to the prior art.

As a result of the much simpler production process, the energy consumption can be minimised and the need for potentially health-injurious chemicals reduced. Together with the realisable savings in material owing to the lower thicknesses of the layers, therefore, the resulting process for producing corresponding adhesive tapes, and hence indirectly an advantageous process for preparing rolls, are particularly time-efficient and cost-effective.

Surprisingly it has been found here that the reduction in the thickness of the carrier layer and/or adhesive layer not only has substantially no adverse effect on the service life of the prepared roll, i.e. the time before it is necessary to renew the bonded covering, but instead that through the use of relatively thin adhesive tapes it is possible advantageously to increase the service lives of the rolls themselves, since the tendency for imprints of the adhesive tape to appear in the roll, or the depth of the resultant imprints, can be minimised even after relatively long operating times. Furthermore, there are advantages apparent in relation to reduced formation of imprints in the coating or in the substrate. Because of the simpler production procedure, moreover, the ETFE-based carrier layers are subject to fewer restrictions on the realisable width, thus enabling greater flexibility in the design of the adhesive tapes.

The process of the invention is suitable advantageously for substantially all typical rolls which are employed in customary coating plants. In an illustrative process of the invention, the roll has a diameter typically in the range of 200 to 1500 mm, preferably in the range from 400 to 1000 mm, and/or the lateral face of the roll has a length typically in the range from 200 to 20000 mm, preferably in the range from 400 to 1600 mm. In another illustrative process of the invention, the lateral face of the roll has a surface which at least in sections, preferably over the entire lateral face, has a macroscopic structuring, the macroscopic structuring preferably comprising a multiplicity of elements selected from the group consisting of knobs, wells and furrows.

The inventors have succeeded accordingly, in relation to the surface nature of the rolls, in identifying certain configurations in which the adhesive tape used in the process of the invention exhibits a particularly high performance, more particularly a good adhesion, and with which, in relation to the bonded surface covering, particularly advantageous service lives are achievable. Preferred, indeed, is a process of the invention wherein the lateral face of the roll has a surface composed of a material selected from the group consisting of steel, more particularly chromed steel, hard substances, more particularly metal carbides, and plastics, more particularly rubber materials.

The inventors propose implementing the adhesive tape as a pressure-sensitive adhesive tape. In this way it is advantageously possible to remove a protective layer of adhesive tape, worn down as a consequence of the physicochemical stresses experienced during coating, and to prepare the thus-exposed roll again in a process of the invention, without having to expend time and effort in removing residues of the adhesive tape beforehand. Preferred accordingly is a process of the invention wherein the adhesive tape is a pressure-sensitive adhesive tape or where the silicone adhesive is a pressure-sensitive adhesive.

A pressure-sensitive adhesive (PSA), in agreement with the understanding of the skilled person, is an adhesive which possesses pressure-sensitive adhesive properties, i.e. has the capacity to enter into a durable bond with respect to a substrate even under relatively weak applied pressure. Corresponding pressure-sensitive adhesive tapes are customarily redetachable from the substrate substantially without residue after use, and in general have a permanent intrinsic tack even at room temperature, meaning that they have a certain viscosity and touch-tackiness, so that they wet the surface of a substrate even under low applied pressure. The pressure-sensitive adhesiveness of a pressure-sensitive adhesive tape is a product of the use as adhesive of a pressure-sensitive adhesive. Without wishing to be tied to this theory, it is frequently assumed that a PSA may be considered to be a fluid of extremely high viscosity with an elastic component, accordingly having characteristic viscoelastic properties which lead to the above-described durable intrinsic tackiness and pressure-sensitive adhesive capability. It is assumed that with such PSAs, on mechanical deformation, there are viscous flow processes and there is development of elastic forces of resilience. The viscous flow component serves to achieve adhesion, while the elastic forces of resilience component is needed in particular for the achievement of cohesion. The relationships between the rheology and the pressure-sensitive adhesiveness are known in the prior art and described for example in Satas, “Handbook of Pressure Sensitive Adhesives Technology”, third edition, (1999), pages 153 to 203. To characterise the extent of the elastic and viscous components, it is usual to employ the storage modulus (G′) and the loss modulus (G″), which may be ascertained by dynamic mechanical analysis (DMA), using a rheometer, for example as disclosed for example in WO 2015/189323. For the purposes of the present invention, an adhesive is understood preferably to have pressure-sensitive adhesiveness and hence to be a PSA when at a temperature of 23° C. in the deformation frequency range from 10° to 101 rad/sec, G′ and G″ are each situated at least partly in the range from 103 to 107 Pa.

According to the estimation of the inventors, it is possible, as well as the ETFE for use in the invention, to provide further polymers in the carrier layer as well, so making it possible, for example, to optimise further the physicochemical properties of the carrier layer. With a view to the achievable protective effect with respect to hot polymer melts, the invention here proposes that in this case ideally different fluoropolymers are to be used for the combination. Preference is therefore given to a process of the invention wherein the carrier layer, in addition to the ethylene-tetrafluoroethylene copolymer, comprises one or more further (co)polymers, preferably fluoropolymers, the fluoropolymers being preferably selected from the group consisting of PTFE (polytetrafluoroethylene), FEP (poly(tetrafluoroethylene-co-hexafluoropropylene)), PVF (polyvinyl fluoride), PCT FE (polychlorotrifluoroethylene), ECTFE (poly(ethylene-co-chlorotrifluoroethylene)), PVDF (poly(1,1-difluoroethene)) and PFA (perfluoroalkoxy polymers).

An alternative to the use of mixed carrier layers is to implement the carrier layer in multiple plies. According to the estimation of the inventors, this is particularly advantageous since in this way it is possible for example to form the upper sub-ply entirely of ETFE, while a second ply composed of a different polymer ensures that the physicochemical properties can be tailored to the particular end use envisaged. In a preferred process of the invention, therefore, the carrier layer is a multi-ply carrier layer which comprises two or more sub-plies, at least one sub-ply consisting at least partially, preferably substantially completely of ethylene-tetrafluoroethylene copolymer, with the multi-ply carrier layer being producible preferably by coextrusion of ethylene-tetrafluoroethylene copolymer and one or more further polymers.

In spite of the above-described possibilities for combination of ETFE with other polymers in the carrier layer, the skilled person understands that with a view to an optimal achievement of the objects described above, it is preferable for the carrier layer also to be formed predominantly or largely or even substantially entirely of ETFE, with this, correspondingly, being the case for at least one sub-ply in multi-ply carrier layers. Preferred against this background is a process of the invention wherein the carrier layer consists of ethylene-tetrafluoroethylene copolymer to an extent of 50% or more, preferably 70% or more, particularly preferably 90% or more, especially preferably 98% or more, more particularly preferably substantially 100%.

In analogy to the observations above concerning the design of the carrier layer, for the adhesive layer as well it is explicitly preferred if this layer is formed predominantly, largely or even substantially completely by the silicone adhesive. In a preferred process of the invention, accordingly, the adhesive layer consists of the silicone adhesive to an extent of 50% or more, preferably 70% or more, particularly preferably 90% or more, especially preferably 98% or more, more particularly preferably substantially 100%.

It is particularly preferred, accordingly, if a likewise preferred configuration is selected for each of the carrier layer and the adhesive layer.

It may be seen as an advantage of the process of the invention that in terms of the chemical nature of the silicone adhesive, the adhesive tape used is very flexible, and, in the estimation of the inventors, it is possible to use substantially all customary silicone adhesives.

Now a “silicone adhesive” or a “silicone pressure-sensitive adhesive” is understood, in agreement with the understanding of the skilled person, to refer to a (pressure-sensitive) adhesive which to a technically relevant extent comprises one or more silicone polymers. The silicone adhesive preferably comprises these silicone polymers in a combined mass fraction of 30% or more, preferably 40% or more, particularly preferably 40% or more, based on the mass of the silicone adhesive.

The silicone polymers of the silicone adhesives are preferably selected from the group consisting of polydiorganosilixanes and silicone resins, these compounds being available commercially from various manufacturers. With particular preference the silicone adhesive comprises at least one polydiorganosiloxane and at least one silicone resin. The polydiorganosiloxane here is often referred to as “base polymer” and is preferably selected from the group consisting of polydimethylsiloxane, polydiphenylsiloxane, dimethylsiloxane-diphenylsiloxane copolymers, and mixtures of this polydiorganosiloxane. The silicone adhesive preferably comprises polydiorganosiloxanes in a combined mass fraction of 20% or more, preferably 30% or more, particularly preferably 30% or more, especially preferably in a range from 30 to 80%, based on the mass of the silicone adhesives. These polydiorganosiloxanes preferably have a weight-average molecular weight Mw (measured by means of GPC) in the range from 350 000 to 1 000 000 g/mol.

The silicone resin is preferably selected from the group consisting of MQ, MTQ, TQ, MT and MDT resins and mixtures of these resins. With particular preference the at least one silicone resin is an MQ resin. MQ silicone resins are readily available and are notable for very good stability. With very particular preference, where there are two or more silicone resins in the composition of the invention, all of the silicone resins in the PSA are MQ resins. The weight-average molecular weight Mw (measured by means of GPC) of the at least one silicone resin is preferably in the range from 500 to 25 000 g/mol, more preferably in the range from 1100 to 23 000 g/mol, very preferably in the range from 1150 to 18 000 g/mol, especially preferably in the range from 1200 to 7200 g/mol.

In addition to the constituents described above, the silicone adhesives may comprise further constituents, especially auxiliaries and adjuvants, examples being anchoring aids; organic and/or inorganic pigments; fillers such as carbon black, graphite or carbon nanotubes; and organic and/or inorganic particles, e.g. polymethyl methacrylate (PMMA), barium sulfate and/or titanium oxide (TiO₂).

The time-dependent aging of the silicone adhesive, which may be manifested in increasing cohesion and also reduced adhesion, may be reduced significantly in particular through radical crosslinking. This radical crosslinking may be carried out, for example, chemically through the use of BPO derivatives (benzoyl peroxide derivatives) and/or through the use of electron beams. The crosslinking of the silicone adhesives is brought about preferably by means of electron bombardment (electron beam curing, EBC).

According to one preferred embodiment of the present invention, the adhesive tape comprises an addition-crosslinked silicone PSA which is obtainable by reacting:
a) at least one organopolysiloxane having a weight-average molecular weight Mw in the range from 30 000 to 2 000 000 g/mol and containing at least one diorganosiloxane unit and at least two silicon-bonded alkenyl groups, the weight-average molecular weight Mw being determined by gel permeation chromatography in toluene at 23° C. and a flow rate of 1.0 ml/min by means of a modified styrene-divinylbenzene copolymer network as column material and polydimethylsiloxane as standard (14-point calibration in the M_{Peak} range from 400 to 2 300 000 g/mol),
b) at least one compound suitable for the crosslinking of organopolysiloxanes containing alkenyl groups, said compound containing at least two silicon-bonded hydrogen atoms, and
c) at least one silicone resin having a weight-average molecular weight Mw in the range from 500 to 29 999 g/mol and containing at least one structural unit (R¹R²R³SiO_{1/2}), (R¹SiO_{3/2}) or (R¹R²SiO_{2/2}), in which R¹, R² and R³ independently of one another are an organic group and at least one of the radicals, R¹, R² or R³, is an alkenyl group, the weight-average molecular weight Mw being determined by gel permeation chromatography in toluene at 23° C. and a flow rate of 1.0 ml/min by means of a modified styrene-divinylbenzene copolymer network as column material and polydimethylsiloxane as standard (14-point calibration in the M_{Peak} range from 400 to 2 300 000 g/mol),

where the reaction of components a), b) and c) is accelerated by a catalyst.

As organopolysiloxanes a) it is possible in particular to use linear, cyclic or branched polydialkylsiloxanes. Particular preference is given to using linear polydimethylsiloxanes and polydimethylsiloxanes which contain terminal and/or internal alkenyl groups as component a).

The combined mass fractions of each of the components are preferably for a) in the range from 30 to 70%, more preferably in the range from 35 to 65%, for b) in the range from 5 to 15%, more preferably in the range from 7 to 12%, and for c) in the range from 20 to 60%, more preferably in the range from 25 to 55%, based in each case on the combined mass of components a), b) and c), which adds up to 100%.

It is possible, illustratively, to use addition-crosslinking systems consisting of silicone resins, polydimethyl-or polydiphenylsiloxanes and crosslinkers (crosslinker substances, especially functionalised hydrosilanes) DC 7657, DC 2013 from Dow Corning, PSA 6574 from GE Bayer Silicones, KR 3700 and KR 3701 from ShinEtsu.

Against this background, very general preference is given to a process of the invention wherein the silicone adhesive is a pressure-sensitive silicone adhesive, preferably a crosslinked pressure-sensitive silicone adhesive, more preferably a chemically crosslinked pressure-sensitive silicone adhesive. Preference is given additionally or alternatively to a process of the invention, wherein the silicone adhesive comprises at least one condensation-crosslinked or addition-crosslinking silicone, preferably an addition-crosslinking silicone. Likewise preferred additionally or alternatively is a process of the invention wherein the silicone adhesive comprises at least one organopolysiloxane and at least one organopolysiloxane resin.

As explained above, it may be seen as advantageous, in light of the demand for material needed, to implement the carrier layer and/or the outer layer, and therefore the entire adhesive tape as well, with as low a thickness as possible. The advantage of the process of the invention may now be seen also in particular in that the adhesive tape employed, in contrast to the prior art, permits an implementation having a reduced mean thickness without any disadvantageous influence on the mechanical properties and the service lives of the rolls thus prepared. As explained above, moreover, it has surprisingly been found that a thinner implementation of the adhesive tapes, which is made possible in the context of the present invention, not only does not have substantial disadvantages in terms of the service lives of the bonded covering, but that instead, surprisingly, the lifetime of the rolls thus covered can be advantageously increased. Against this background it is unambiguously preferred for the adhesive tapes used and/or the individual layers used to be made correspondingly thin as well. Preferred accordingly is a process of the invention wherein the carrier layer has a mean thickness in the range from 20 to 200 μm, preferably in the range from 30 to 150 μm, particularly preferably in the range from 40 to 100 μm. Preferred, additionally or alternatively, is a process of the invention wherein the adhesive layer has a mean thickness in the range from to 100 μm, preferably in the range from 20 to 75 μm. In a particularly preferred process of the invention, the adhesive tape has a mean thickness in the range from 50 to 250 μm, preferably in the range from 60 to 170 μm, preferably in the range from 70 to 120 μm.

Accordingly, the inventors have also succeeded in identifying suitable ranges for the surface weight of the silicone adhesive in corresponding adhesive tapes. Preference, indeed, is given to a process of the invention wherein the surface weight of the silicone adhesive in the adhesive tape is in the range from 10 to 100 g/m², preferably in the range from 20 to 50 g/m².

It may be seen as an advantage of the process of the invention that it can be used to realise a multiplicity of possible bonded covering patterns of the prepared rolls which as a result can be tailored to the requirements of the particular usage scenario. With a view to a reliable process regime and to secure affixing of the adhesive tape on the roll, it is preferred, according to the estimation of the inventors, for the adhesive tape to be guided at least once around the roll for a bonded covering. Preference is therefore also given to a process of the invention wherein the adhering of the adhesive tape to the lateral face of the roll is such that the lateral face is wrapped with the adhesive tape over the entire circumference, at least in sections, as for example at two or more sections spaced apart from one another along the longitudinal direction of the roll.

In the light of the ready colourability of ETFE as compared with the PTFE known from the prior art, it is advantageous also to utilise this favourable property in order to facilitate the handling of the adhesive tapes and in particular in operation to enable visual quality control of the bonded covering of the roll. In a preferred process of the invention, the carrier layer is coloured at least in sections, preferably completely.

The invention also relates to a process for coating a perforate substrate with a coating plant, comprising the process steps of the process of the invention of preparing rolls, and also the process steps of:
d) contacting a substrate to be coated with the lateral face of the prepared roll, the substrate to be coated having one or more continuous clearances, and
e) applying a coating material to that side of the substrate to be coated that is facing away from the prepared roll,

wherein the contacting of the substrate to be coated with the lateral face of the prepared roll takes place such that the one or the two or more continuous clearances lie at least partly, preferably substantially completely, above a region, covered by the adhesive tape of the lateral face of the prepared roll, so that contact between the lateral face and the coating material is at least partly, preferably substantially completely, prevented by the adhesive tape in the region of the one or of the two or more continuous clearances.

The process of the invention for coating a perforate substrate with a coating plant is based on the process of the invention for preparing rolls, since a roll prepared by the corresponding process of the invention is used in the coating plant. In agreement with the understanding of the skilled person, the expression “perforate substrate” here identifies a substrate which possesses at least one continuous clearance, it being possible for this continuous clearance to have a round or angular embodiment, for example.

In the light of the observations above, the skilled person understands that the coating process of the invention relates in particular to extrusion coating. Relevant for the majority of end uses, therefore, is a process of the invention wherein the coating plant is a plant for extrusion coating, and/or wherein the coating takes place by means of extrusion coating, and/or wherein the coating material is applied as a melt, preferably a polymer melt.

In the coating process, the underside of the substrate to be coated is guided over the prepared roll, and so the lateral face thereof contacts the substrate to be coated from below, and so this substrate, on rotation of the prepared roll, can be guided through the coating plant. In process step e), then, the coating material, i.e. usually the hot polymer melt, is applied to the substrate to be coated, with application taking place from above in such a way that the substrate lies between the prepared roll and the coating unit of the coating plant. The assembly thus generated, composed of the substrate to be coated and the hot polymer melt applied, is subsequently passed through the roll arrangement of the coating plant, with the polymer melt being shaped to a flat layer and being cooled by cooled rolls, so that it solidifies in the desired layer thickness. This process of the invention is now conducted such that, based on the direction from which the coating material is applied to the substrate, it is not the mere lateral face of the prepared roll that is exposed beneath the continuous clearances in the substrate, but instead that this lateral face is covered in this region by the adhesive tape, more precisely by the carrier layer of the adhesive tape, so that the hot polymer melt, in spite of the clearances in the substrate, does not impinge directly on the roll body, but is instead kept away by the adhesive tape.

The process of the invention is especially suitable for the sector of the packaging industry, especially in connection with the coating of typical packaging material which is subsequently processed into individual packs. In a preferred process of the invention, therefore, the substrate to be coated comprises one or more materials selected from the group consisting of paper, card, metal foils, especially aluminium foil, and polymeric film. In a particularly preferred process of the invention, the substrate to be coated is a packaging material, more particularly a beverage carton. Preferred additionally or alternatively is a process of the invention wherein the continuous clearances are preferably spaced apart from one another, more preferably substantially equidistantly, along the direction of travel of the substrate through the coating plant.

By virtue of the high chemical resistance of the ETFE-based carrier layer, the process of the invention is suitable advantageously for a wide range of different polymers, including in particular for coating with polyethylene. In a preferred process of the invention, the coating material is a polymer, the polymer being selected from the group consisting of polyethylene, polypropylene, polyvinyl alcohol, polylactides, polyhydroxyalkanoates, polyamides, polyvinyl chloride, ethylene-vinyl acetate copolymer and other copolymers, and also biopolymers, preferably from the group consisting of polyethylene, and polypropylene, more particularly polyethylene.

The skilled person understands in the light of the observations above that the invention relates, moreover, to an adhesive tape for preparing rolls for use in coating plants, preferably for use in the process of the invention, comprising:
i) a carrier layer, the carrier layer consisting at least partly of ethylene-tetrafluoroethylene copolymer,
ii) an adhesive layer disposed on the carrier layer, the adhesive layer consisting at least partly of a silicone adhesive, and
iii) a release material disposed on the adhesive layer.

The adhesive tape of the invention comprises, as a covering for the adhesive layer, a release material which can be removed by the user before being employed in the process of the invention and which ensures that a fresh, unsoiled adhesive layer is obtained. The release material thereby improves the handling properties of the adhesive tape of the invention. The release material is intended correspondingly for removal from the adhesive layer before the adhesive tape is adhered.

In an illustrative adhesive tape of the invention, the release material comprises one or more polymers selected from the group consisting of polyethylene-vinyl alcohol, polyethylene naphthalate, polyethylene, polypropylene, cycloolefin copolymers and polyvinylidene chloride.

With a view to extremely easy detachability of the release material prior to use, it has proved to be conducive to provide the release material with what is called a release layer, which reduces the adhesion between the release material and the adhesive layer. Relevant in this context in particular are what are called fluorosilicone release layers. Such fluorosilicone release layers are generally produced by a condensation system based on a fluorinated hydroxy-silicone (MQ resin) and a fluorinated silane (Si—H functionality) using a tin catalyst, or alternatively via an addition system composed of a fluorinated vinyl-silane and a fluorinated silane using a platinum catalyst. In a preferred adhesive tape of the invention, therefore, the release material is coated on one or both sides with a release layer, the release layer preferably being a fluorosilicone release layer, and the fluorosilicone release layer being producible with very particular preference by crosslinking of a crosslinkable fluorinated silicone system comprising one or more fluorinated polysiloxanes.

On this basis, the invention also relates to the use of an adhesive tape of the invention for preparing rolls for use in coating plants by adhering the adhesive tape to the lateral face of the roll for the purpose of increasing the service life of the roll and/or for prolonging maintenance intervals.

Accordingly, moreover, the invention relates to a prepared roll, preferably produced or producible by the process of the invention, having a lateral face which is intended for contact with a substrate to be coated, the lateral face of the prepared roll being covered at least partly by an adhesive tape, the adhesive tape comprising:
i) a carrier layer, the carrier layer consisting at least partly of ethylene-tetrafluoroethylene copolymer,
ii) an adhesive layer disposed on the carrier layer, the adhesive layer consisting at least partly of a silicone adhesive.

Preference is given, in analogy to the observations above, to a prepared roll of the invention, the prepared roll being covered by the adhesive tape at least in sections, preferably at two or more sections spaced apart from one another along the longitudinal direction of the roll, over the entire circumference.

The invention lastly relates to a coating plant for coating substrates, preferably in a process of the invention, comprising:
j) one or more rolls which are configured to guide and/or to process a substrate to be coated, at least one roll being a prepared roll of the invention, and
k) a coating unit, which is configured to apply a coating material to that side facing away from the prepared roll of a substrate to be coated that has been contacted by the prepared roll.

Preference is given in this context to a coating plant of the invention wherein the coating unit is an extruder.

Disclosed, furthermore, is a process for producing an adhesive tape of the invention, comprising the steps of:
x) producing or providing a carrier layer, the carrier layer consisting at least partly of ethylene-tetrafluoroethylene copolymer,
y) activating at least one surface of the carrier layer by means of corona treatment or plasma activation, preferably corona treatment, to give an activated surface, and
z) applying a silicone adhesive to the activated surface of the carrier layer and shaping an adhesive layer from the silicone adhesive.

Preferred accordingly is a production process of the invention wherein the adhesive layer is shaped with a comma bar or a coating nozzle. Preferred additionally or alternatively is a production process of the invention wherein the carrier layer is produced by flat film extrusion. Preferred additionally or alternatively likewise is a corresponding production process wherein the silicone adhesive in the course of the production is crosslinked by the influence of temperature, electron beams, ultra-violet radiation or moisture. Also preferred, lastly, is a corresponding production process wherein the corona activation takes place at less than 300° C.

Below, preferred embodiments of the invention are elucidated in more detail and described with reference to the appended figures, in which:

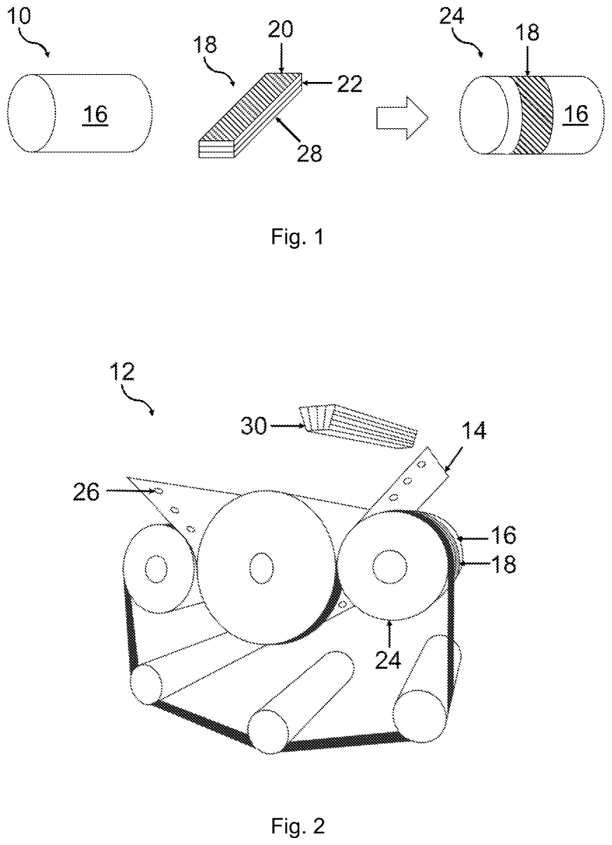

FIG. 1 shows a schematic representation of an illustrative roll and of an adhesive tape of the invention for use in a process of the invention for obtaining a prepared roll of the invention;

FIG. 2 shows a schematic representation of a coating plant of the invention in one preferred embodiment, in a first view;

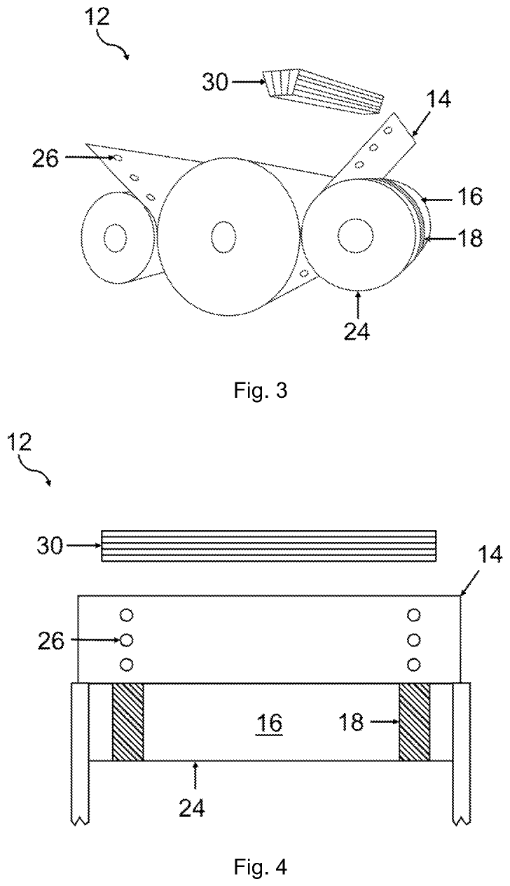

FIG. 3 shows a schematic representation of a coating plant of the invention in a second preferred embodiment; and

FIG. 4 shows a schematic representation of a part of the coating plant of the invention from FIG. 2, in a second view.

FIG. 1 shows schematically an illustrative roll 10 of a coating plant and an adhesive tape 18 of the invention in one preferred embodiment for use in a process of the invention for obtaining a prepared roll 24.

In the example shown, the roll 10 is formed of chromed steel and possesses a rubber coating on the lateral face 16. The roll 10 in the example shown has a diameter of 600 mm.

The adhesive tape 18 is adhesive on one side and comprises, one atop another, a carrier layer 20, an adhesive layer 22 and a release material 28. In the example shown, the release material 28 consists of PET and is coated on both sides with a fluorosilicone release layer. In the course of the process of the invention, the release material 28 is removed, for the adhesive tape 18 to be stuck by the adhesive layer 22 to the roll 10. Correspondingly, the thickness of the adhesive tape 18 after adhering is defined substantially by the thicknesses of the carrier layer 20 and of the adhesive layer 22, which in the example shown are 70 μm and up to 25 μm, respectively.

In the example of FIG. 1, the carrier layer 20 consists entirely of ethylene-tetrafluoroethylene copolymer, has a bluish colouration, and has been produced by flat film extrusion. The adhesive layer 22 consists entirely of a chemically crosslinked pressure-sensitive silicone adhesive which comprises a condensation-crosslinked silicone, the pressure-sensitive silicone adhesive having a surface weight in the region of about 25 g/m². On the surface of the roll 10, the adhesive tape 18 of the invention has a peel adhesion of more than 2.5 N/cm, this being particularly preferred for the planned usage.

To obtain an adhesive tape 18 of the invention of this kind, the surface of the carrier layer 20, prior to the application of the pressure-sensitive silicone adhesive, is activated by means of corona treatment at a temperature of not more than 300° C. The pressure-sensitive silicone adhesive can then be applied to the activated surface of the carrier layer 20. The adhesive layer 22 is shaped from the silicone adhesive by means of a comma bar.

In the process of the invention, as indicated by the arrow in FIG. 1, the adhesive tape 18 is mounted by the adhesive layer 22 on the roll 10 in such a way that the surface of the prepared roll 24, resulting from the joining of adhesive tape 18 and roll 10, is formed by the carrier layer 20 at the corresponding position over the entire circumference.

FIGS. 2 and 3 show preferred embodiments of a coating plant 12 of the invention for the coating of substrates 14 in the context of the implementation of a coating process of the invention, in preferred embodiments. The respective coating plant 12 of the invention comprises for this purpose a plurality of rolls for guiding and/or processing the substrate 14 to be coated.

The coating plant 12 of the invention is designed in each case as a plant for extrusion coating and comprises, accordingly, a coating unit 30, disposed above the roll arrangement, this unit 30 in the example shown being an extruder. The extruder is configured to distribute the coating material, polyethylene for example, in the form of a hot polymer melt in a relatively uniform way over the substrate 14, allowing this substrate to be shaped by the roll arrangement in which the larger, central roll is a water-cooled steel roll which also promotes the solidification of the polymer layer. In order to prevent damage to the roll arrangement by the hot polymer melt, the coating plant of the invention comprises a roll 24 prepared in accordance with the invention. FIG. 2 additionally shows, in a marginal region of the roll arrangement, a belt guided over the entire roll arrangement, which serves to protect the rolls in the side regions. A belt of this kind can be produced, for example, if two adhesive tapes 18 of the invention are joined via the adhesive layers 22 and joined to form a continuous belt, in which the carrier layers 20 of ETFE are on the outside. This belt is not represented in FIG. 3, in order to improve the visibility of the bonded covering with the adhesive tape.

In the example shown, the substrate 14 is a beverage carton, i.e., a semi-finished carton product of the kind used, for example, in the production of milk packaging. Such beverage cartons in the folded state, as the outlet aperture, have a clearance 26, which may already be present when the starting material is coated.

FIG. 4 shows a detail of a coating plant 12, which in terms of the fundamental arrangement is comparable with the structure of FIG. 2; in this detail, the view is a perpendicular one onto the lateral face 16 of the prepared roll 24, and corresponding belts are provided in both side regions, these belts being indicated in each case at the margins of the prepared roll 24.

As can be seen in FIG. 4, a multiplicity of clearances 26 are spaced equidistantly apart from one another along the direction of passage of the substrate 14 through the coating plant 12, and, in the representation shown, they are also arranged in two rows in the substrate 14, with the rows being spaced apart along the longitudinal direction of the prepared roll 24. In order to take account of this circumstance, the lateral face 16 is wrapped with the adhesive tape 18 over the entire circumference at the two sections corresponding to the positions of the clearances and spaced apart along the longitudinal direction of the roll 24.

In a process of the invention for coating the substrate 14 with the coating plant 12 of the invention, the substrate 14 to be coated is first disposed on the lateral face 16 of the prepared roll 24. The coating unit 30 then brings the coating material, in the form of a polymer melt, onto that side of the substrate 14, contacted from below, that is facing away from the prepared roll 24. The disposition of the substrate 14 on the prepared roll 24 in this case is such that the clearances 26 lie completely above that region of the lateral face 16 of the prepared roll 24 that is covered with the adhesive tape 18, so substantially completely preventing contact between the lateral face 16 and the coating material in the region of the clearances 26 by means of the adhesive tape 18.

Below, preferred embodiments of the invention are elucidated further and described with reference to experiments.

A. Sample Production

As adhesive, a pressure-sensitive silicone adhesive is produced from products available commercially. Production took place from a mixture of vinyl-PDMS, MQ resin and silane crosslinker (trade name DOWSIL 7657 from Dow Chemical) using a platinum crosslinker (0.5% trade name SYL-OFF 4000 from Dow Chemical).

The pressure-sensitive silicone adhesive was applied from solvent, with the pressure-sensitive silicone adhesive being crosslinked after the drying or evaporation of the solvent at elevated temperatures of about 180° C.

The release material used was a PET liner provided on one side with a fluorosilicone release layer (trade name SILFLU S 50 M 1 R88002 WHITE from Siliconature S.p.a.)

To produce the adhesive tape E1 of the invention, the pressure-sensitive silicone adhesive produced was applied by comma bar coating with a surface weight of 25 g/m² to a blue-coloured ETFE film whose surface immediately prior to the application of the PSA was activated by corona treatment. The ETFE film has a substantially constant thickness of 50 μm (weight around 89 g/m²) and a production width of 1300 mm. After the drying of the assembly, the release material was applied to the adhesive layer. The resultant adhesive tape E1 had a total thickness (without release material) of about 72 μm.

To produce the adhesive tape E2 of the invention, the pressure-sensitive silicone adhesive produced was applied by comma bar coating with a surface weight of 33 g/m² to a transparent ETFE film whose surface immediately prior to the application of the PSA was activated by corona treatment. The ETFE film has a substantially constant thickness of 80 μm (weight around 142 g/m²) and a production width of 500 mm. After the drying of the assembly, the release material was applied to the adhesive layer. The resultant adhesive tape E2 had a total thickness (without release material) of about 112 μm.

Employed as comparative sample V1 was a PTFE-based commercial product from tesa, which is available commercially as “tesa 4820”. The pressure-sensitive silicone adhesive processed in this product is the same as in adhesive tapes E1 and E2, with the resultant adhesive layer applied on a PTFE film with a thickness of about 75 μm (weight around 153 g/m²) that has been activated, in a manner typical for PTFE, by an etching operation with sodium naphthalide. The surface weight of the applied adhesive is about 25 g/m². The adhesive tape V1 had a total thickness (without release material) of about 100 μm.

Employed as comparative sample V2 was a PTFE-based commercial product from Nitto, which is available commercially as “NITOFLON Nr. 923S”. A pressure-sensitive silicone adhesive is processed in this product, with the adhesive layer being applied at a coatweight of about 50 g/m² to a PTFE film having a thickness of about 50 μm (weight around 134 g/m²) The adhesive tape V2 had a total thickness (without release material) of about 104 μm.

B. Experiments

B1. Technical Adhesive Properties

For the samples V1, V2, E1 and E2, determinations were made, as described below, of the peel adhesion on steel, the anchoring strength by measurement against etched PET film, and the micro-shear travel under temperature load.

The peel adhesions on steel were determined in analogy to ISO 29862 (Method 3) at 23° C. and 50% relative humidity with a removal velocity of 300 mm/min and a removal angle of 180°. The substrates used were steel plates in accordance with the standard. The measurement strip of the respective adhesive tapes was bonded by means of a roller application machine at 4 kg and a temperature of 23° C. The adhesive tapes were removed immediately after application. The measurement value (in N/cm) was obtained as the mean value from three individual measurements.

To determine the anchoring of the PSA on the carrier, a T-peel test was carried out as is described in WO 2017140775 A1. For this test, the adhesive tape was laminated onto the chemically etched surface of a PET film. Removal took place using a T-peel machine which is set to a constant rate and which measures the force needed for the maintenance of this constant rate. The measurement value (in N/cm) was obtained as the mean value from three individual measurements.

The shear strength under temperature load was determined by means of a micro-shear test. For this purpose, a sample specimen (length around 50 mm, width 10 mm) cut from the respective adhesive tape was bonded to a steel test plate which had been cleaned with acetone, with the steel plate projecting beyond the adhesive tape to the right and the left and with the adhesive tape protruding beyond the test plate at the upper margin by 2 mm. The bond area of the sample was 13 mm×10 mm (height×width). The bond side was then rolled over three times using a 2 kg steel roller at a rate of 10 m/min. The sample specimen thus applied was reinforced flush with a stable adhesive strip which served as a support for the travel sensor. The sample thus prepared was suspended vertically by means of the test plate, and loaded at the lower end with a weight of 100 g. The test temperature was 40° C., the test duration 15 minutes. The parameter determined was the distance of shear after the specified test duration at constant temperature, with the value being reported in μm and being the maximum distance of shear after loading for 15 minutes.

B2. Mechanical Properties

For the samples V1, V2, E1 and E2, the tensile strength and the elongation at break were determined on sample specimens having a clamped length of 100 mm, which were loaded at 300 mm/min along the web direction. The experiments were conducted on a Zwick Roell 2020 universal testing machine from Zwick GmbH.

B3. Performance Properties

The samples V1, V2, E1 and E2 were used for preparing steel opposed rolls of a polyethylene extrusion coating plant and were tested under typical service conditions. The useful life of the bonded covering, i.e. the time until it was necessary to renew the adhesive tape; the residue of adhesive remaining on the roll on removal; and the handling suitability on detachment of the melted LD-PE were evaluated qualitatively by trained employees with many years of experience in the area of extrusion coating, with the performance being better the more “+” were awarded.

C. Results

The results of the experiments described above are compiled in table 1 below, with the technical adhesive and mechanical properties of V1 being taken from the corresponding product specification.

TABLE 1
Results of measurements

| | | | | | |
|---|---|---|---|---|---|
| Property | Unit | V1 | V2 | E1 | E2 |

Technical adhesive properties

| | | | | | |
|---|---|---|---|---|---|
| Peel adhesion (steel) | N/cm | 2.5 | 3.1 | 3.5 | 4.2 |
| Anchoring force | N/ cm | >6 | 5.8 | 7.8 | 7.5 |
| (etched PET) | | | | | |
| Shear test | μm | <50 | 29 | 15 | 12 |

Mechanical properties

| | | | | | |
|---|---|---|---|---|---|
| Tensile strength | N/15 mm | >79 | 82 | 42 | 44 |
| Elongation at break | % | >100 | 128 | 280 | 337 |

Performance properties

| | | | | | |
|---|---|---|---|---|---|
| Service life of bonded | − | + | ++ | +++ | ++++ |
| covering | | | | | |
| Residues of adhesive | − | + | ++ | +++ | +++ |
| Handling suitability | − | + | ++ | +++ | +++ |

From the results it is apparent that adhesive tapes of the invention exhibit advantageous peel adhesion on steel and etched PET and also a favourable shear behaviour at elevated temperatures. Moreover, adhesive tapes of the invention possess mechanical properties which are advantageous for the target application, and in performance testing they exhibit consistently improved performance properties. These advantages are also manifested in particular when the adhesive tapes are made relatively thin.

### LIST OF REFERENCE SIGNS

10 roll
12 coating plant
14 substrate
16 lateral face
18 adhesive tape
20 carrier layer
22 adhesive layer
24 prepared roll
26 clearance
28 release material
30 coating unit

1. A process for preparing rolls for use in coating plants, the process comprising:
a) providing a coating plant with a roll having a lateral face configured for contact with a substrate to be coated;
b) producing or providing an adhesive tape comprising
i) a carrier layer consisting at least partly of ethylene-tetrafluoroethylene copolymer, and
ii) an adhesive layer disposed on the carrier layer and consisting at least partly of a silicone adhesive; and
c) adhering the adhesive tape to the lateral face of the roll by means of the adhesive layer to give or provide a prepared roll, wherein the adhering takes place such that the lateral face of the prepared roll is covered at least partly by the adhesive tape.

2. The process of claim 1, wherein the adhesive tape is a pressure-sensitive adhesive tape.

3. The process of claim 1, wherein the carrier layer has a mean thickness in the range from 20 to 200 μm.

4. The process of claim 2, wherein the carrier layer is a multi-ply carrier layer comprising two or more sub-plies, wherein at least one sub-ply consists of at least partly of ethylene-tetrafluoroethylene copolymer.

5. The process of claim 4, wherein the carrier layer, additionally to the ethylene-tetrafluoroethylene copolymer, comprises one or more fluoropolymers selected from the group consisting of PTFE (polytetrafluoroethylene), FEP (poly(tetrafluoroethylene-co-hexafluoropropylene)), PVF (polyvinyl fluoride), PCT FE (polychlorotrifluoroethylene), ECTFE (poly(ethylene-co-chlorotrifluoroethylene)), PVDF (poly(1,1-difluoroethene)) and PFA (perfluoroalkoxy polymers).

6. A process for coating a perforate substrate with a coating plant, the process comprising:
c) preparing rolls according to claim 1;
d) contacting a substrate to be coated with the lateral face of the prepared roll, the substrate to be coated having one or more continuous clearances; and
e) applying a coating material to that side of the substrate to be coated that is facing away from the prepared roll,
wherein the contacting of the substrate to be coated with the lateral face of the prepared roll takes place such that the one or the two or more continuous clearances lie at least partly above a region, covered by the adhesive tape of the lateral face of the prepared roll, so that contact between the lateral face and the coating material is at least partly prevented by the adhesive tape in the region of the one or of the two or more continuous clearances.

7. An adhesive tape for preparing rolls for use in the process of claim 6, the adhesive tape comprising:
i) a carrier layer consisting at least partly of ethylene-tetrafluoroethylene copolymer;
ii) an adhesive layer disposed on the carrier layer and consisting at least partly of a silicone adhesive, and
iii) a release material disposed on the adhesive layer.

8. A method comprising:
adhering the adhesive tape of claim 7 to a lateral face of the roll for the purpose of increasing the service life of the roll and/or for prolonging maintenance intervals.

9. A prepared roll produced by the process of claim 1, the prepared roll having a lateral face configured for contact with a substrate to be coated, wherein the lateral face of the prepared roll is covered at least partly by an adhesive tape, and the adhesive tape comprises:
i) a carrier layer consisting at least partly of ethylene-tetrafluoroethylene copolymer, and
ii) an adhesive layer disposed on the carrier layer and consisting at least partly of a silicone adhesive.

10. A coating plant for coating substrates in the process of claim 6, the coating plant comprising:
one or more rolls configured to guide and/or to process a substrate to be coated, wherein at least one roll is a prepared roll; and
a coating unit configured to apply a coating material to the side facing away from the prepared roll of a substrate to be coated that has been contacted by the prepared roll.
